(19) United States
(12) Patent Application Publication
(10) Pub. No.: US 2016/0020862 A1
(43) Pub. Date: Jan. 21, 2016

(54) IMPEDANCE TUNING FOR A POWER AMPLIFIER LOAD TUNER, A RECEIVE TUNER, AND AN ANTENNA TUNER

(71) Applicant: QUALCOMM Incorporated, San Diego, CA (US)

(72) Inventors: Ali Morshedi, San Diego, CA (US); Robert Lloyd Robinett, San Diego, CA (US)

(21) Appl. No.: 14/334,421

(22) Filed: Jul. 17, 2014

(51) Int. Cl. H04B 17/12; H04B 17/21

(52) U.S. Cl. CPC H04B 17/12; H04B 17/21

(57) ABSTRACT

An apparatus includes a transmit path that includes a power amplifier load tuner having an adjustable impedance. The apparatus also includes a receive path that includes a receive tuner having an adjustable impedance. The apparatus further includes an antenna tuner having an adjustable impedance. The antenna tuner is coupled to the transmit path and to the receive path.

### I. FIELD

The present disclosure is generally related to impedance tuning for a power amplifier load tuner, a receive tuner, and an antenna tuner.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

A wireless communications device may receive and transmit signals using a transceiver. The transceiver may include a power amplifier load tuner that is tunable to improve transmission performance of the wireless communications device. For example, the power amplifier load tuner may be tuned (e.g., impedance tuning) to improve transmission metrics (e.g., power added efficiency, linearity, output power, or any combination thereof). The transceiver may also include a receive tuner that is tunable to improve signal reception quality. For example, the receive tuner may be tuned (e.g., impedance tuning) to improve noise figure (e.g., the signal-to-noise ratio (SNR)) of received signals. An antenna tuner may be tuned to reduce reflected transmission power of the wireless communications device transmission path and to reduce return loss of various antennas coupled to the wireless communications device. Impedance tuning to improve transmission metrics may impact signal reception quality, and impedance tuning to improve signal reception quality may impact transmission metrics.

### III. BRIEF DESCRIPTION OF THE DRAWINGS

FIG. 1 shows a wireless device communicating with a wireless system;

FIG. 2 shows a block diagram of the wireless device in FIG. 1;

FIG. 3 is a diagram that depicts an exemplary embodiment of a system that is operable to tune components of a transceiver;

FIG. 4 is a diagram that depicts another exemplary embodiment of a system that is operable to tune components of a transceiver; and

FIG. 5 is a flowchart that illustrates an exemplary embodiment of a method for tuning components of a transceiver.

### IV. DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

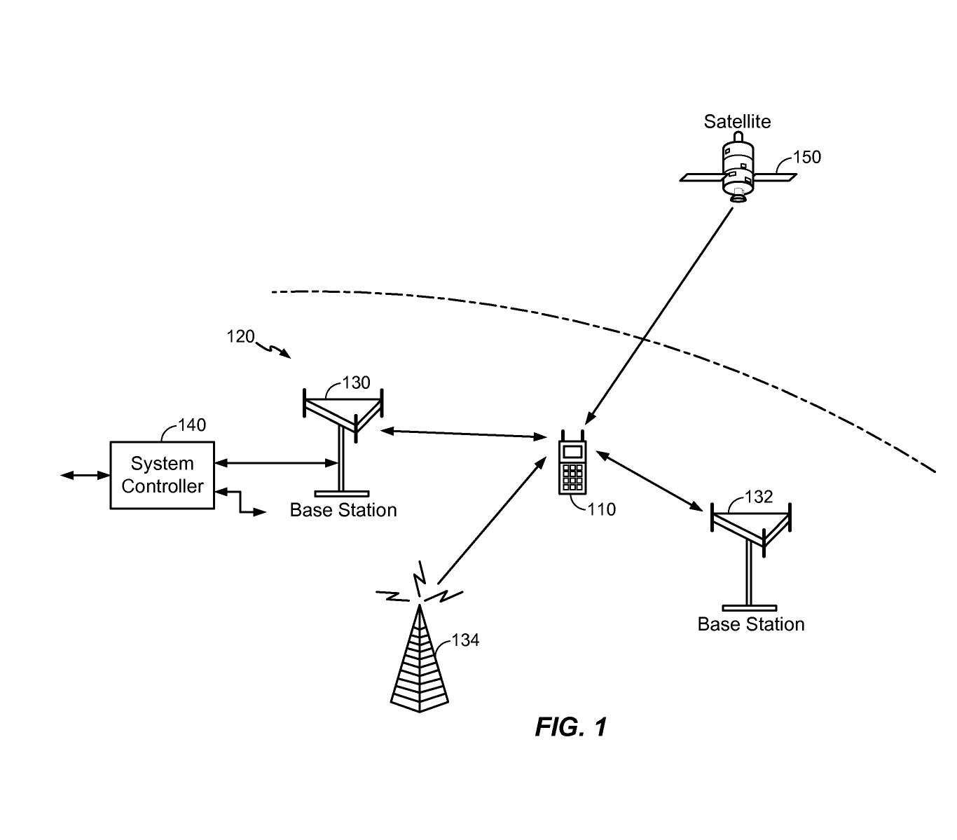

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1×, EVDO, TD-SCDMA, GSM, 802.11, etc.

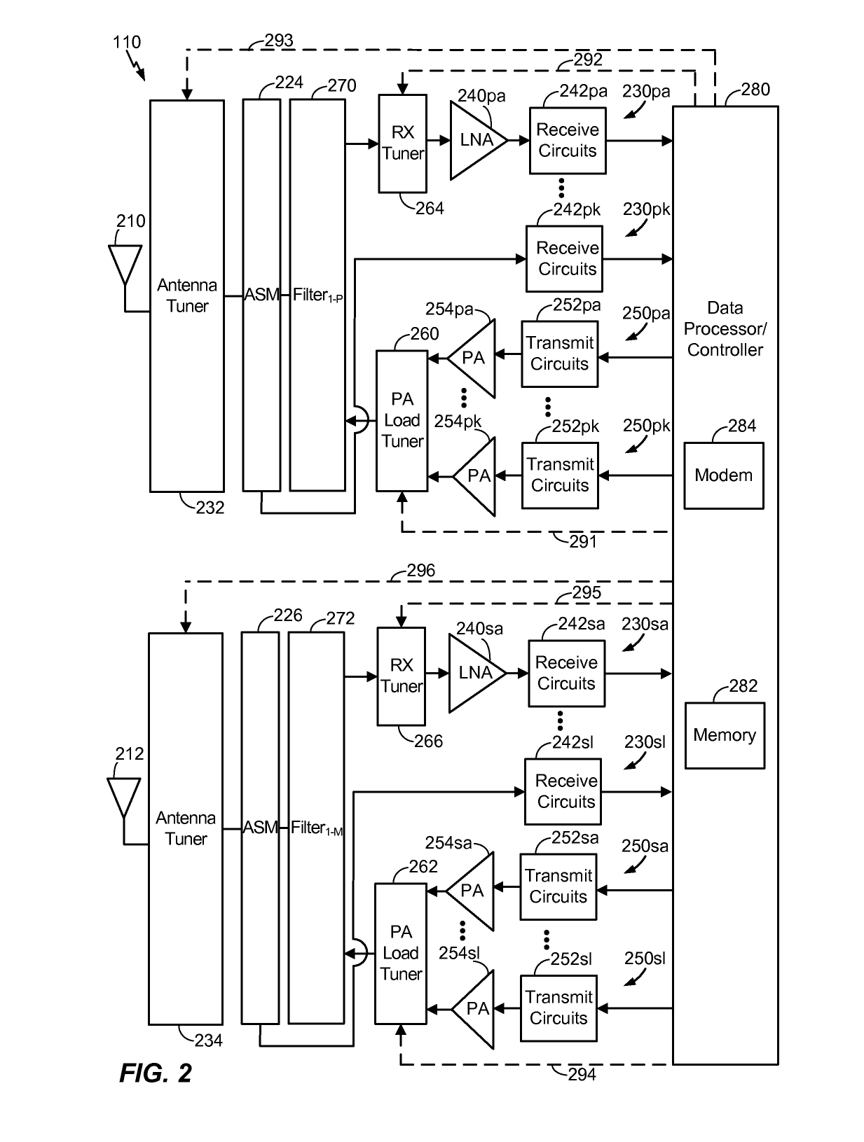

FIG. 2 shows a block diagram of an exemplary design of the wireless device 110 in FIG. 1. In this exemplary design, the wireless device 110 includes a first transceiver coupled to a primary antenna 210, a second transceiver coupled to a secondary antenna 212, and a data processor/controller 280. The first transceiver includes multiple (K) receivers 230pa to 230pk and multiple (K) transmitters 250pa to 250pk support multiple frequency bands, multiple radio technologies, carrier aggregation, receive diversity, multiple-input multiple-output (MIMO) transmission from multiple transmit antennas to multiple receive antennas, etc. The second transceiver includes multiple (L) receivers 230sa to 230sl and multiple (L) transmitters 250sa to 250sl to support multiple frequency bands, multiple radio technologies, carrier aggregation, receive diversity, MIMO transmission from multiple transmit antennas to multiple receive antennas, etc.

In the exemplary design shown in FIG. 2, each receiver 230pa to 230pk and 230sa to 230sl includes a low noise amplifier (LNA). As an illustrative example, the receiver 230pa includes an LNA 240pa, and the receiver 230sa includes an LNA 240sa. The receiver 230pk may also include an LNA (not shown), and the receiver 230sl may also include an LNA (not shown). Each receiver 230pa, 230pk, 230sa, 230sl may also include receive circuits 242pa, 242pk, 242sa, 242sl. The LNA for receiver 230pk may be within the receive circuit 242pk, and the LNA for receiver 230sl may be within the receive circuit 242sl. In an exemplary embodiment, a first feedback LNA (not shown) is in the receive circuit 242pk and a second feedback LNA (not shown) is in the receive circuit 242sl.

For data reception, the antenna 210 receives signals from base stations and/or other transmitter stations and provides a received RF signal, which is routed through an antenna tuner 232, an antenna switching module (ASM) 224, and a filter 270_{1-P} and presented as an input RF signal to a selected receiver. In an exemplary embodiment, P is any integer value greater than zero. As a non-limiting example, if P is equal to twenty, the wireless device 110 includes twenty filters (e.g., duplexers). The ASM 224 may include switches, duplexers, transmit filters, receive filters, matching circuits, etc. The description below assumes that receiver 230pa is the selected receiver. Within the receiver 230pa, a receive (RX) tuner 264 may tune the input RF signal and an LNA 240pa amplifies the input RF signal and provides an output RF signal. The receive circuits 242pa downconvert the output RF signal from RF to baseband, amplify and filter the downconverted signal, and provide an analog input signal to data processor/controller 280. The receive circuits 242pa may include mixers, filters, amplifiers, matching circuits, an oscillator, a local oscillator (LO) generator, a phase locked loop (PLL), etc. Each remaining receiver 230pk and 230sa to 230sl may operate in similar manner as receiver 230pa. For example, the antenna 212 receives signals from base stations and/or other transmitter stations and provides a received RF signal, which is routed through an antenna tuner 234, an ASM 226, and a filter 272_{1-M} and presented as an input RF signal to a selected receiver. In an exemplary embodiment, M is any integer value greater than zero. As a non-limiting example, if M is equal to thirty, the wireless device 110 includes thirty filters (e.g., duplexers). The ASM 226 may include switches, duplexers, transmit filters, receive filters, matching circuits, etc. Within the receiver 230pa, a receive (RX) tuner 266 may tune the input RF signal and an LNA 240sa amplifies the input RF signal and provides an output RF signal. The receive circuits 242sa downconvert the output RF signal from RF to baseband, amplify and filter the downconverted signal, and provide an analog input signal to the data processor/controller 280.

In the exemplary design shown in FIG. 2, each transmitter 250pa to 250pk and 250sa to 250sl includes transmit circuits 252pa to 252pk and 252sa to 252sl and a power amplifier (PA) 254pa to 254pk and 254sa to 254sl, respectively. For data transmission, the data processor/controller 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. The transmit circuits 252pa may include amplifiers, filters, mixers, matching circuits, an oscillator, an LO generator, a PLL, etc. A power amplifier (PA) 254pa receives and amplifies the modulated RF signal and provides a transmit RF signal having the proper output power level. The transmit RF signal is routed through a power amplifier load tuner 260, the filter 270, the ASM 224, and the antenna tuner 232 and transmitted via the antenna 210. Each remaining transmitter 250pk and 250sa to 250sl may operate in similar manner as transmitter 250pa. For example, a transmit RF signal from the transmit circuit 252sl may be routed through a power amplifier load tuner 262, the filter 272, the ASM 226, and the antenna tuner 234 and transmitted via the antenna 212.

In an exemplary embodiment, the impedance of each power amplifier load tuner 260, 262 may be adjustable based on signals 291, 294, respectively, and the impedance of each receive tuner 264, 266 may be adjustable based on signals 292, 295, respectively. Additionally, the impedance of each antenna tuner 232, 234 may be adjustable based on signals 293, 296, respectively. In an exemplary embodiment, the signals 291-296 are digital signals. In another exemplary embodiment, the signals 291-296 are analog signals.

During operation, a modem 284 within the data processor/controller 280 may be configured to generate tuning metrics based on particular uses cases of the wireless device 110. For example, the modem 284 may determine, based on a particular use case (e.g., a downloading operation) of the wireless device 110, to increase the downlink throughput. The modem 284 may determine tuning metrics for one or more of the receive tuners 264, 266 that satisfy a threshold for the increased downlink throughput. If the threshold is not satisfied, the modem 284 may input the tuning metrics into a tuning algorithm to determine updated tuning metrics for the receive tuners 264, 266. The updated tuning metrics to increase the downlink throughput may be provided to the receive tuners 264, 266 as signals 292, 295, and the impedance of the receive tuners 264, 266 may be adjusted to increase downlink throughput based on the signals 292, 295 (e.g., tuned for enhanced noise figure). Updated tuning metrics may also be provided to the antenna tuners 232, 234 as signals 293, 296 to reduce the return loss at the antenna tuners 232, 234 for increased downlink throughput.

After the receive tuners 264, 266 and the antenna tuners 232, 234 have been “tuned” for increased downlink throughput (e.g., primary tuning during a first time period), the modem 284 may tune one or more of the power amplifier load tuners 260, 262 (e.g., secondary tuning during a second time period after the first time period) to achieve the “best possible” transmission tuning metrics (e.g., adjacent channel leakage ratio (ACLR)) available. The power amplifier load tuners 260, 262 may be tuned to achieve the “best possible” transmission metrics based on the tuned (e.g., adjusted) impedance of the antenna tuners 232, 234, respectively. Although primary tuning for the receive tuners 264, 266 and the antenna tuners 232, 234 were described with respect to increased downlink throughput, primary tuning for the receive tuners 264, 266 and the antenna tuners 232, 234 may be performed for other use cases. For example, primary tuning for the receive tuners 232, 234 and the antenna tuners 232, 234 may be performed when the wireless device 110 is on a cell edge with low uplink traffic and when the wireless device 110 is near a base station in a dense small cell.

The modem 284 may perform primary tuning during the first time period for the power amplifier load tuners 260, 262 and the antenna tuners 232, 234 for other use cases. For example, the modem 284 may perform primary tuning for the power amplifier load tuners 260, 262 and the antenna tuners 232, 234 when the wireless device 110 has a good received SNR or to increase power throttling. During primary tuning for the power amplifier load tuners 260, 262 and the antenna tuners 232, 234, the modem 284 may first tune the antenna tuners 232, 234 and the power amplifier load tuners 260, 264 for the particular use case during the first time period, and then tune the receive tuners 264, 266 (e.g., secondary tuning during the second time period) to achieve the “best possible” reception metrics (e.g., noise figure) available. The receiver tuners 264, 266 may be tuned to achieve the “best possible” reception metrics based on the tuned (e.g., adjusted) impedance of the antenna tuners 232, 234, respectively.

FIG. 2 shows an exemplary design of receivers 230pa to 230pk and 230sa to 230sl and an exemplary design of transmitters 250pa to 250pk and 250sa to 250sl. A receiver and a transmitter may also include other circuits not shown in FIG. 2, such as filters, matching circuits, etc. All or a portion of transceivers may be implemented on one or more analog integrated circuits (ICs), RF ICs (RFICs), mixed-signal ICs, etc.

The data processor/controller 280 may perform other various functions for wireless device 110. For example, data processor/controller 280 may perform processing for data being received via the receivers 230pa to 230pk and 230sa to 230sl and data being transmitted via the transmitters 250pa to 250pk and 250sa to 250sl. The data processor/controller 280 may control the operation of the various circuits within transceivers. A memory 282 may store program code and data for the data processor/controller 280. The data processor/controller 280 may be implemented on one or more application specific integrated circuits (ASICs) and/or other ICs.

The wireless device 110 may support multiple band groups, multiple radio technologies, and/or multiple antennas. The wireless device 110 may include a number of LNAs to support reception via the multiple band groups, multiple radio technologies, and/or multiple antennas.

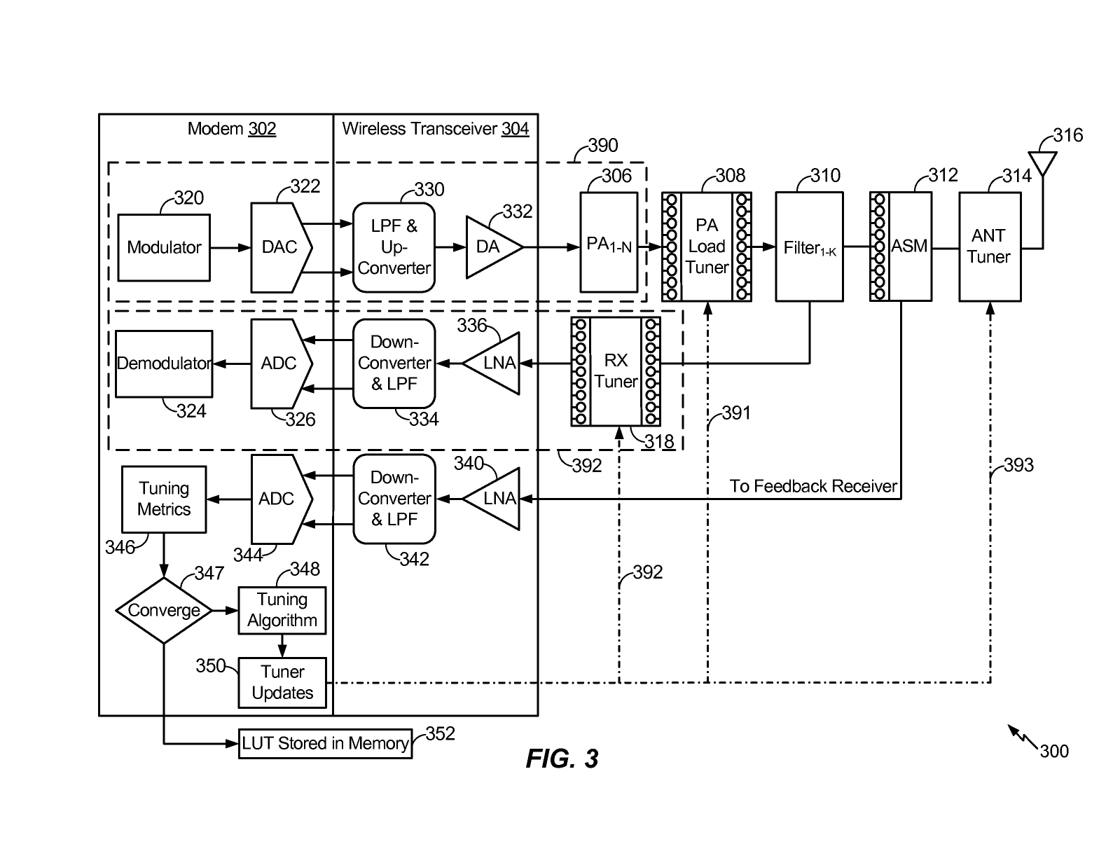

Referring to FIG. 3, an exemplary embodiment of a system 300 that is operable to tune components of a transceiver is shown. In an exemplary embodiment, the system 300 may be implemented within the wireless device 110 of FIGS. 1-2. The system 300 includes a modem 302, a wireless transceiver 304, power amplifiers 306_{1-N}, a power amplifier load tuner 308, filters 310_{1-K}, an antenna switching module (ASM) 312, an antenna (ANT) tuner 314, and a receive (RX) tuner 318. In an exemplary embodiment, the modem 302 may correspond to the modem 284 of FIG. 2.

In an exemplary embodiment, N and K are any integer values greater than zero. As a non-limiting example, if N is equal to twenty and K is equal to twenty-five, the system 300 may include twenty power amplifiers 306 and twenty-five filters 310. In another exemplary embodiment, N and K may correspond to the same integer value. For example, if N and K are each equal to twenty, the system 300 may include twenty power amplifiers 306 and twenty filters 310.

In an exemplary embodiment, the power amplifier load tuner 308 corresponds to one or more of the power amplifier load tuners 260, 262 of FIG. 2, the filters 310_{1-K} corresponds to one or more of the filters 270, 272 of FIG. 2, the ASM 312 corresponds to one or more of the ASMs 224, 226 of FIG. 2, the antenna tuner 314 corresponds to one or more of the antenna tuners 232, 234 of FIG. 2, and the receive tuner 318 corresponds to one or more of the receive tuners 264, 266 of FIG. 2.

The modem 302 may include a modulator 320 coupled to a digital-to-analog converter 322. The modulator 320 and the digital-to-analog converter 322 may be included within a transmit path 390 (e.g., transmission circuitry). The modulator 320 may be configured to modulate a carrier signal with a modulated signal (e.g., a digital signal bit stream) and provide the resulting signal to the digital-to-analog converter 322. The digital-to-analog converter 322 may be configured to convert the resulting signal from a digital signal into an analog signal.

The wireless transceiver 304 may include a low pass filter and up-converter 330 and a driver amplifier 332. The low pass filter and up-converter 330 and the driver amplifier 332 may also be included in the transmit path 390. The low pass filter and up-converter 330 may filter particular frequencies of the analog signal provided from the digital-to-analog converter 322. The low pass filter and up-converter 330 may also up-convert the analog signal from a baseband frequency signal (or intermediate frequency signal) to a radio frequency signal (e.g., an up-converted signal). The up-converted signal may be provided to the driver amplifier 332. The driver amplifier 332 (e.g., an intermediate amplifier) may be configured to amplify the up-converted signal and provide the amplified up-converted signal to the power amplifiers 306.

Each power amplifier 306 may be configured to amplify the analog signal received from the driver amplifier 332. The amplified signals may be provided to the power amplifier load tuner 308. Each power amplifier 306 may be associated with a distinct transmission frequency and may be selectively coupled to the power amplifier load tuner 308 based on the transmission frequency. For example, in an exemplary embodiment, an active power amplifier (e.g., a power amplifier associated with a frequency band in which signals are to be transmitted) may be coupled to the power amplifier load tuner 308 via a switch (e.g., a multiplexer), and inactive power amplifiers (e.g., power amplifiers associated with frequency bands in which signals are not being transmitted) may be decoupled from the power amplifier load tuner 308 via the switch.

The power amplifier load tuner 308 may include multiple input ports. Each input port of the power amplifier load tuner 308 may be associated with a distinct frequency and may be selectively coupled to a corresponding power amplifier 306. As a non-limiting example, the system 300 may include twenty power amplifiers 306 (N=20) (e.g., a first power amplifier 306₁, a second power amplifier 306₂, a third power amplifier 306₃, etc.) and the power amplifier load tuner 308 may include twenty input ports (e.g., a first input port, a second input port, a third input port, etc.). Each power amplifier 306 may be selectively coupled to the corresponding input port based on the transmission frequency of the system 300. For example, the first power amplifier 306₁ may be coupled to the first input port via the switch when transmission signals are to be transmitted over a first transmission frequency, the second power amplifier 306₂ may be coupled to the second input port via the switch when transmission signals are to be transmitted over a second transmission frequency, etc.

An impedance of the power amplifier load tuner 308 may be adjustable based on a selected input port and a use case, as described below, of a wireless device (e.g., the wireless device 110 of FIGS. 1-2). For example, the power amplifier load tuner 308 may include a controller configured to receive a first signal 391 and to adjust the impedance of the power amplifier load tuner 308 based on the first signal 391. For example, in an exemplary embodiment, the power amplifier load tuner 308 may include at least one capacitor bank and/or at least one inductor. Based on the first signal 391, the controller may selectively activate (or deactivate) at least one capacitor of the at least one capacitor bank and/or may selectively activate the at least one inductor to adjust the impedance of the power amplifier load tuner 308. In an exemplary embodiment, the first signal 391 is a digital signal. In another exemplary embodiment, the first signal 391 is an analog signal.

The power amplifier load tuner 308 may also include multiple output ports. In an exemplary embodiment indicative of synchronous port selection, the number of output ports may correspond to the number of input ports of the power amplifier load tuner 308. Each output port may be selectively coupled to a corresponding filter 310 via a switch (e.g., a multiplexer). For example, a first filter 310₁ may be tuned to the first transmission frequency, a second filter 310₂ may be tuned to the second transmission frequency, etc. A first output port of the power amplifier load tuner 308 may be selectively coupled to the first filter 310₁ via the switch, a second output port of the power amplifier load tuner 308 may be selectively coupled to the second filter 310₂ via the switch, etc.

In the exemplary embodiment indicative of synchronous port selection, the first output port of the power amplifier load tuner 308 may be coupled to the first filter 310₁ via the switch when the first input port of the power amplifier load tuner 308 is coupled to the first power amplifier 306₁ to enable a transmission signal that is amplified by the first power amplifier 306₁ to be filtered by the first filter 310₁ (e.g., filtered based on the first transmission frequency). In a similar manner, the second output port of the power amplifier load tuner 308 may be coupled to the second filter 310₂ via the switch when the second input port of the power amplifier load tuner 308 is coupled to the second power amplifier 306₂ to enable a transmission signal that is amplified by the second power amplifier 306₂ to be filtered by the second filter 310₂, etc.

In an exemplary embodiment indicative of asynchronous port selection, an input port of the power amplifier load tuner 308 may be active (e.g., coupled to a corresponding power amplifier 306) and a non-corresponding output port of the power amplifier load tuner 308 may be active. For example, the first power amplifier 306₁ may be coupled to the power amplifier load tuner 308 via the first input port of the power amplifier load tuner 308, and the first or second filter 310₁-310₂ may be coupled to the first or second output port of the power amplifier load tuner 308, respectively, to enable asynchronous port selection. Thus, the first power amplifier 306₁ may transmit over two or more frequency bands (e.g., a frequency band associated with the first filter 310₁ or a frequency band associated with the second filter 310₂) to reduce the number of passive matching components in the power amplifier load tuner 308.

Outputs of the filters 310 may be provided to the ASM 312. The ASM 312 may enable an output of the filters 310 (e.g., a transmission signal) to be provided to a feedback receiver, as described below. Alternatively, the ASM 312 may enable signal transmission over a wireless network via an antenna 316. For example, an output of the ASM 312 may be provided to the antenna tuner 314, and an output of the antenna tuner may be transmitted over the wireless network via the antenna 316. The antenna tuner 314 may have the adjustable impedance based on the use case of the wireless device. For example, the impedance of the antenna tuner 314 may adjusted (e.g., tuned) to reduce reflected transmission power (e.g., tuned for enhanced transmissions) or may be tuned to reduce return loss (e.g., tuned for enhanced reception). A third signal 393 may be provided to the antenna tuner 314 to adjust the impedance based on the use case. In an exemplary embodiment, the third signal 393 is a digital signal. In another exemplary embodiment, the third signal 393 is an analog signal.

The system 300 may also include a receive path 392 (e.g., reception circuitry) to process received signals. For example, the receive path 392 may include the receiver tuner 318, a low noise amplifier 336, a down-converter and low pass filter 334, an analog-to-digital converter 326, and a demodulator 324. The low noise amplifier 336 and the down-converter and low pass filter 334 may be included in the wireless transceiver 304, and the demodulator 324 and the analog-to-digital converter 326 may be included in the modem 302.

During signal reception, radio frequency signals may be received via the antenna 316 and provided to the filters 310 via the antenna tuner 314 and the ASM 312. The filters 310 may be configured to filter the received radio frequency signals, and a resulting signal may be provided to the receive tuner 318.

The receive tuner 318 may include multiple input ports. Each input port of the receive tuner 318 may be associated with a distinct frequency and may be selectively coupled to a corresponding filter 310. An impedance of the receive tuner 318 may be adjustable based on a selected input port and the use case of the wireless device. For example, the receive tuner 318 may include a controller configured to receive a second signal 392 and to adjust the impedance of the receive tuner 318 based on the second signal 392. In an exemplary embodiment, the second signal 392 is a digital signal. In another exemplary embodiment, the second signal 392 is an analog signal.

An output of the receive tuner 318 may be provided to the low noise amplifier 336. The low noise amplifier 336 may be configured to amplify and adjust the gain of the received signals. The output signals of the low noise amplifier 336 may be down-converted and filtered by the down-converter and low pass filter 334. The output of the down-converter and low pass filter 334 may be converted into a digital signal via the analog-to-digital converter 326, and the output of the analog-to-digital converter 326 may be demodulated by the demodulator 324.

The antenna switching module 312 may enable the transmission signal (or incoming radio frequency signals) to be provided to the feedback receiver. The feedback receiver may include a low noise amplifier 340, a down-converter and low pass filter 342, and an analog-to-digital converter 344. The low noise amplifier 340 may be configured to amplify and adjust the gain of the transmission signal (or the incoming radio frequency signals), the down-converter and low pass filter 342 may be configured to down-convert and filter the output of the low noise amplifier 340, and the analog-to-digital converter 344 may be configured to convert the output of the down-converter and low pass filter 342 into a digital feedback signal (e.g., a digital signal representative of the transmission signal (or the incoming radio frequency signals)). Although feedback to the feedback receiver is enabled using the ASM 312, in other exemplary embodiments, other components may enable feedback to the feedback receiver. For example, a coupler may be placed on the transmit path 390 to enable feedback to the feedback receiver.

During operation, the modem 302 may determine the use case of the wireless device and generate tuning metrics 346 based on the use case. For example, modem 302 may determine whether components (e.g., the power amplifier load tuner 308, the antenna 314, and the receive tuner 318) of the wireless device should be tuned to primarily enhance signal transmission or tuned to primarily enhance signal reception. The determination may be based, at least in part, on the use case of the wireless device. As non-limiting examples, use cases that may benefit from enhanced signal transmission (e.g., primary tuning of the power amplifier load tuner 308) include scenarios where the wireless device already has a relatively high received SNR and scenarios where power throttling of the wireless device is low and needs to increase because of temperature conditions. Use cases that may benefit from enhanced signal reception (e.g., primary tuning of the receive tuner 318) include scenarios where the wireless device already has a relatively high power headroom needs increased downlink throughput, scenarios where the wireless device is on a cell edge with low uplink traffic, and scenarios where the wireless device is near a base station in a dense small cell.

If the modem 302 determines that signal transmission should be primarily enhanced based on the use case, the modem 302 may first tune (e.g., perform primarily tuning on) the power amplifier load tuner 308 and the antenna tuner 314. For example, the modem 302 may provide the first signal 391 to the power amplifier load tuner 308 to adjust the impedance of the power amplifier load tuner 308 for enhanced signal transmissions, and the modem 302 may provide the third signal 393 to the antenna tuner 314 to adjust the impedance of the antenna tuner 314 for reduced reflected transmission power. After the impedance of the power amplifier load tuner 308 and the antenna tuner 314 are adjusted, the modem 302 may tune (e.g., perform secondary tuning) the receive tuner 318 to achieve the “best possible” signal reception.

The modem 302 may perform primary tuning on the power amplifier load tuner 308 and the antenna tuner 314 during a first time period based on the digital feedback signal that is representative of the transmission signal. For example, based on the digital feedback signal, the modem 302 may be configured to determine a power added efficiency of the transmission signal, a linearity of the transmission signal, an adjacent channel leakage ratio of the transmission signal, an output power of the transmission signal, an error vector magnitude associated with the transmission signal, or any combination thereof. During an on-line process (e.g., when the modem 302 is connected to a wireless network), the modem 302 may be configured to determine whether one or more of the tuning metrics 346 satisfy a threshold. For example, based on the particular power amplifier 306 coupled to the power amplifier load tuner 308 (e.g., based on the transmission frequency), the modem 302 may determine whether at least one of the tuning metrics 346 satisfy an associated threshold. To illustrate, the modem 302 may determine whether the power added efficiency of the transmission signal at a particular frequency (e.g., when a particular power amplifier 306 and corresponding filter 310 is coupled to the power amplifier load tuner 308) satisfies a power added efficiency threshold based on information associated with the digital feedback signal. Although the following example is described with respect to power added efficiency, it will be appreciated that tuning based on other tuning metrics 346 (e.g., linearity, adjacent channel leakage ratio, output power, error vector magnitude, etc.) may be performed.

If the power added efficiency of the transmission signal at the particular frequency satisfies the power added efficiency threshold, the modem 302 may converge the tuning values of the power amplifier load tuner 308 and the antenna tuner 314 as the tuning value for power added efficiency, at 347, and may store the tuning values of the power amplifier load tuner 308 in a lookup table of a memory 352. The tuning values stored in the lookup table of the memory 352 may be accessed when the modem 302 is off-line (e.g., when the modem 302 is disconnected from a wireless network) to tune (e.g., calibrate) the power amplifier load tuner 308 and the antenna tuner 314 to a desired impedance for power added efficiency. In another exemplary embodiment, the modem 302 may be on-line (e.g., the modem 302 may be connected to the wireless network) and the tuning values may be “retuned” via the feedback receiver (i.e., the modem 302 may recalibrate the antenna tuner 314 and the power amplifier load tuner 308 while on-line).

If the power added efficiency of the transmission signal at the particular frequency fails to satisfy the power added efficiency threshold, the modem 302 may input the power added efficiency into a tuning algorithm 348 to determine updated tuning values 350 for the power amplifier load tuner 308 and the antenna tuner 314. In an exemplary embodiment, the tuning algorithm 348 may correspond to the Nelder-Mead algorithm. For example, the tuning algorithm 348 may extrapolate behavior of the digital feedback signal for a particular metric to determine tuning values 350 (e.g., capacitance values and/or inductance values) based on the behavior. The updated tuning values 350 may be provided to the power amplifier load tuner 308 and to the antenna tuner 314 as the first signal 391 and the third signal 393, respectively. After the impedance of the power amplifier load tuner 308 and the antenna tuner 314 are adjusted based on the signals 391, 393, the modem 302 may provide the second signal 392 to the receive tuner 318 to tune for enhanced signal reception (e.g., the “best possible” signal reception) based on the impedance of the antenna tuner 314.

If the modem 302 determines that signal reception should be primarily enhanced based on the use case, the modem 302 may first tune (e.g., perform primarily tuning on) the receive tuner 318 and the antenna tuner 314. For example, the modem 302 may provide the second signal 392 to the receive tuner 318 to adjust the impedance of the received tuner 318 for enhanced signal reception, and the modem 302 may provide the third signal 393 to the antenna tuner 314 to adjust the impedance of the antenna tuner 314 for reduced return loss. After the impedance of the receive tuner 318 and the antenna tuner 314 are adjusted, the modem 302 may tune (e.g., perform secondary tuning on) the power amplifier load tuner 308 to achieve the “best possible” signal transmission.

The modem 302 may perform primary tuning on the receive tuner 318 and the antenna tuner 314 based on the digital feedback signal that is representative of the incoming radio frequency signals. For example, based on the digital feedback signal, the modem 302 may be configured to determine a noise figure (e.g., a SNR). The modem 302 may determine whether the noise figure of the incoming radio frequency signals satisfy a noise figure threshold based on information associated with the digital feedback signal.

If the noise figure satisfies the noise figure threshold, the modem 302 may converge the tuning values of the receive tuner 318 and the antenna tuner 314 as the tuning value for noise figure, at 347, and may store the tuning values of the receive tuner 318 and the antenna tuner 314 in the lookup table of the memory 352. The tuning values stored in the lookup table of the memory 352 may be accessed when the modem 302 is off-line (e.g., when the modem 302 is disconnected from a wireless network) to tune (e.g., calibrate) the receive tuner 318 and the antenna tuner 314 to a desired impedance for noise figure. In another exemplary embodiment, the modem 302 may be on-line (e.g., the modem 302 may be connected to the wireless network) and the tuning values may be “retuned” via the feedback receiver (i.e., the modem 302 may recalibrate the antenna tuner 314 and the receive tuner 318 while on-line).

If the noise figure fails to satisfy the noise figure threshold, the modem 302 may input the noise figure into a tuning algorithm 348 to determine updated tuning values 350 for the receive tuner 318 and the antenna tuner 314. The updated tuning values 350 may be provided to the receive tuner 318 and to the antenna tuner 314 as the second signal 392 and the third signal 393, respectively. After the impedance of the receive tuner 318 and the antenna tuner 314 are adjusted based on the signals 391, 393, the modem 302 may provide the first signal 391 to the power amplifier load tuner 308 to tune for enhanced signal transmission (e.g., the “best possible” signal transmission) based on the impedance of the antenna tuner 314.

The system 300 of FIG. 3 may enable dynamic impedance tuning for transceiver components (e.g., the power amplifier load tuner 308, the antenna tuner 314, and the receive tuner 318) based on use cases. For example, to enhance signal transmission based on the use case, the modem 302 may primarily tune the power amplifier load tuner 308 and the antenna tuner 314 for enhanced signal transmission. Afterwards, the modem 302 may tune (e.g., secondary tuning) the receive tuner 318 for the “best possible” signal reception. Alternatively, to enhance signal reception based on the use case, the modem 302 may primarily tune the receive tuner 318 and the antenna tuner 314 for enhanced signal transmission. Afterwards, the modem may tune the power amplifier load tuner 308 for the “best possible” signal transmission.

It will also be appreciated that the modem 302 may tune the power amplifier load tuner 308, the antenna tuner 314, and the receive tuner 318 at a “compromise” point for certain use cases. For example, when the wireless device is on a cell edge with high uplink traffic, the modem 302 may tune the impedance of the antenna tuner 314 for a balance (e.g., a “compromise”) between return loss and reflected transmission power. Additionally, the modem 302 may tune the impedance of the power amplifier load tuner 308 for improved output power and may tune the impedance of the receive tuner 318 for improved noise figure.

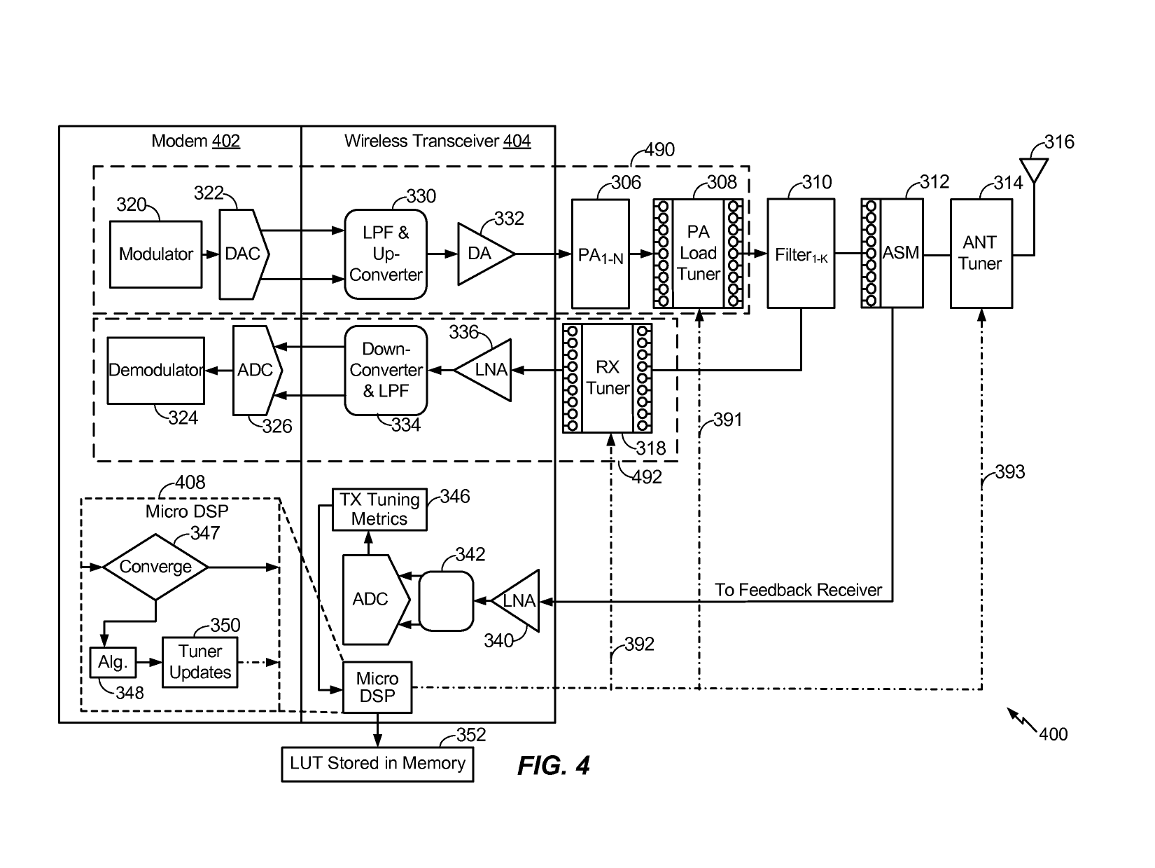

Referring to FIG. 4, another exemplary embodiment of a system 400 that is operable to tune components of a transceiver is shown. In an exemplary embodiment, the system 400 may be implemented in the wireless device 110 of FIGS. 1-2. The system 400 includes a modem 402, a wireless transceiver 404, the power amplifiers 306_{1-N}, the power amplifier load tuner 308, the filters 310_{1-N}, the ASM 312, the antenna tuner 314, the antenna 316, and the receive tuner 318.

The modem 402 may include the modulator 320, the digital-to-analog converter 322, the demodulator 324, and the analog-to-digital converter 326. The wireless transceiver 404 may include the low pass filter and up-converter 330, the driver amplifier 332, down-converter and low pass filter 334, and the low noise amplifier 336. The modulator 320, the digital-to-analog converter 322, the low pass filter and up-converter 330, and the driver amplifier 332 may be included within a transmit path 490 and may operate in a substantially similar manner as described with respect to FIG. 3. The demodulator 324, the analog-to-digital converter 326, the down-converter and low pass filter 334, and the low noise amplifier 3336 may be included within a receive path 492 and may operate in a substantially similar manner as described with respect to FIG. 3.

The power amplifiers 306_{1-N}, the power amplifier load tuner 308, the filters 310_{1-N}, the ASM 312, the antenna tuner 314, the antenna 316, and the receive tuner 318 may also operate in a substantially similar manner as described with respect to FIG. 3. The wireless transceiver 404 may also include a feedback receiver. The feedback receiver may include the low noise amplifier 340, the down-converter and low pass filter 342, the analog-to-digital converter 344, and a micro digital signal processor 408. The wireless transceiver 404 may determine the transmission tuning metrics 346 based on the digital feedback signal (e.g., the output of the analog-to-digital converter 344).

The micro digital signal processor (DSP) 408 may determine the use case of the wireless device and generate tuning metrics 346 based on the use case. For example, the micro DSP 408 may determine whether components (e.g., the power amplifier load tuner 308, the antenna 314, and the receive tuner 318) of the wireless device should be tuned to primarily enhance signal transmission or tuned to primarily enhance signal reception. The determination may be based, at least in part, on the use case of the wireless device. As non-limiting examples, use cases that may benefit from enhanced signal transmission (e.g., primary tuning of the power amplifier load tuner 308) include scenarios where the wireless device already has a relatively high received SNR and scenarios where power throttling of the wireless device is low and needs to increase because of temperature conditions. Use cases that may benefit from enhanced signal reception (e.g., primary tuning of the receive tuner 318) include scenarios where the wireless device already has a relatively high power headroom needs increased downlink throughput, scenarios where the wireless device is on a cell edge with low uplink traffic, and scenarios where the wireless device is near a base station in a dense small cell.

If the micro DSP 408 determines that signal transmission should be primarily enhanced based on the use case, the micro DSP 408 may first tune (e.g., perform primarily tuning on) the power amplifier load tuner 308 and the antenna tuner 314. For example, the micro DSP 408 may provide the first signal 391 to the power amplifier load tuner 308 to adjust the impedance of the power amplifier load tuner 308 for enhanced signal transmissions, and the micro DSP 408 may provide the third signal 393 to the antenna tuner 314 to adjust the impedance of the antenna tuner 314 for reduced reflected transmission power. After the impedance of the power amplifier load tuner 308 and the antenna tuner 314 are adjusted, the micro DSP 408 may tune (e.g., perform secondary tuning) the receive tuner 318 to achieve the “best possible” signal reception.

If the micro DSP 408 determines that signal reception should be primarily enhanced based on the use case, the micro DSP 408 may first tune (e.g., perform primarily tuning on) the receive tuner 318 and the antenna tuner 314. For example, the micro DSP 408 may provide the second signal 392 to the receive tuner 318 to adjust the impedance of the received tuner 318 for enhanced signal reception, and the micro DSP 408 may provide the third signal 393 to the antenna tuner 314 to adjust the impedance of the antenna tuner 314 for reduced return loss. After the impedance of the receive tuner 318 and the antenna tuner 314 are adjusted, the micro DSP 408 may tune (e.g., perform secondary tuning) the power amplifier load tuner 308 to achieve the “best possible” signal transmission.

The system 400 of FIG. 4 may enable dynamic impedance tuning for transceiver components (e.g., the power amplifier load tuner 308, the antenna tuner 314, and the receive tuner 318) based on use cases. For example, to enhance signal transmission based on the use case, the micro DSP 408 may primarily tune the power amplifier load tuner 308 and the antenna tuner 314 for enhanced signal transmission. Afterwards, the modem 302 may tune (e.g., secondary tuning) the receive tuner 318 for the “best possible” signal reception. Alternatively, to enhance signal reception based on the use case, micro DSP 408 may primarily tune the receive tuner 318 and the antenna tuner 314 for enhanced signal transmission. Afterwards, the modem may tune the power amplifier load tuner 308 for the “best possible” signal transmission.

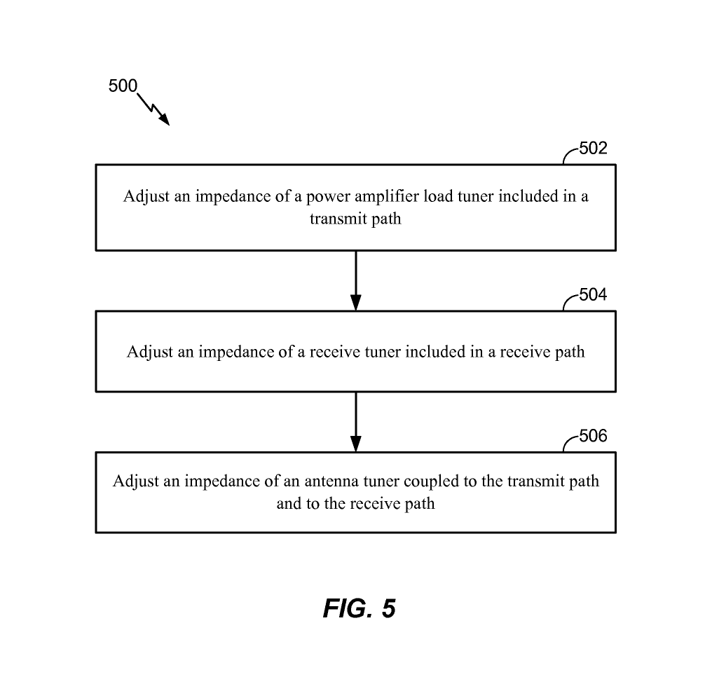

Referring to FIG. 5, a flowchart that illustrates an exemplary embodiment of a method 500 for tuning components of a transceiver is shown. In an illustrative embodiment, the method 500 may be performed using the wireless device 110 of FIGS. 1-2, the system 300 of FIG. 3, the system 400 of FIG. 4, or any combination thereof.

The method 500 includes adjusting an impedance of a power amplifier load tuner included in a transmit path, at 502. For example, referring to FIG. 3, the impedance of the power amplifier load tuner 308 may be adjusted based on the use case of the wireless device 110. The modem 302 may provide the first signal 391 to the power amplifier load tuner 308 to adjust the impedance of the power amplifier load tuner 308.

An impedance of a receive tuner in a receive path may be adjusted, at 504. For example, referring to FIG. 3, the impedance of the receive tuner 318 may be adjusted based on the use case of the wireless device 110. The modem 302 may provide the second signal 392 to the receive tuner 318 to adjust the impedance of the receive tuner 318.

An impedance of an antenna tuner coupled to the transmit path and to the receive path may be adjusted, at 506. For example, referring to FIG. 3, the impedance of the antenna tuner 314 may be adjusted based on the use case of the wireless device 110. The modem 302 may provide the third signal 393 to the antenna tuner 314 to adjust the impedance of the antenna tuner 314.

According to the method 500, the impedance of the power amplifier load tuner 308 and the impedance of the antenna tuner 314 may be adjusted based on the use case prior to adjusting the impedance of the receive tuner 318 in response to a determination that the use case is associated with signal transmission. For example, primary tuning may be performed on the power amplifier load tuner 308 and on the antenna tuner 314 to enhance signal transmission, and secondary tuning may be performed on the receive tuner 318 to achieve a “best possible” signal reception after the primary tuning.

Alternatively, the impedance of the receive tuner 317 and the impedance of the antenna tuner 314 may be adjusted based on the use case prior to adjusting the impedance of the power amplifier load tuner 308 in response to a determination that the use case is associated with signal reception. For example, primary tuning may be performed on the receive tuner 318 and on the antenna tuner 314 to enhance signal reception, and secondary tuning may be performed on the power amplifier load tuner 308 to achieve a “best possible” signal transmission after the primary tuning.

The method 500 of FIG. 5 enable dynamic impedance tuning for transceiver components (e.g., the power amplifier load tuner 308, the antenna tuner 314, and the receive tuner 318) based on use cases.

In conjunction with the described embodiments, an apparatus includes means for transmitting that includes a power amplifier load tuner having an adjustable impedance. For example, the means for transmitting may include the transmit path 390 of FIG. 3, the transmit path 490 of FIG. 4, one or more other devices, circuits, modules, or any combination thereof.

The apparatus may also include means for receiving that includes a receive tuner having an adjustable impedance. For example, the means for receiving may include the receive path 392 of FIG. 3, the receive path 492 of FIG. 4, one or more other devices, circuits, modules, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. In an exemplary embodiment, the tuning algorithm 348 may be implemented using software that is executable by a processor. In another exemplary embodiment, the controller 526 may be implemented using software that is executable by a processor. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a transmit path that includes a power amplifier load tuner having an adjustable impedance;
a receive path that includes a receive tuner having an adjustable impedance; and
an antenna tuner having an adjustable impedance, the antenna tuner coupled to the transmit path and to the receive path.

2. The apparatus of claim 1, further comprising a processor configured to generate a first signal, a second signal, and a third signal, wherein the impedance of the power amplifier load tuner is adjusted based on the first signal, the impedance of the receive tuner is adjusted based on the second signal, and the impedance of the antenna tuner is adjusted based on the third signal.

3. The apparatus of claim 2, wherein the processor is included in a modem of a wireless device.

4. The apparatus of claim 2, wherein the processor is integrated into a radio frequency integrated circuit.

5. The apparatus of claim 2, wherein the processor is further configured to:
adjust the impedance of the power amplifier load tuner and adjust the impedance of the antenna tuner during a first time period based on a use case of a wireless device; and
adjust the impedance of the receive tuner during a second time period based on the adjusted impedance of the antenna tuner.

6. The apparatus of claim 5, wherein the first time period precedes the second time period, and wherein the use case of the wireless device is associated with a transmit configuration.

7. The apparatus of claim 2, wherein the processor is further configured to:
adjust the impedance of the receive tuner and adjust the impedance of the antenna tuner during a first time period based on a use case of a wireless device; and
adjust the impedance of the power amplifier load tuner during a second time period based on the adjusted impedance of the antenna tuner.

8. The apparatus of claim 7, wherein the first time period precedes the second time period, and wherein the use case of the wireless device is associated with a receive configuration.

9. The apparatus of claim 1, further comprising an antenna coupled to the antenna tuner.

10. The apparatus of claim 1, further comprising at least one power amplifier coupled to the power amplifier load tuner.

11. The apparatus of claim 1, further comprising at least one filter coupled to the power amplifier load tuner and to the receive tuner.

12. An apparatus comprising:
means for transmitting that includes a power amplifier load tuner having an adjustable impedance; and
means for receiving that includes a receive tuner having an adjustable impedance,
wherein the means for transmitting and the means for receiving are coupled to an antenna tuner having an adjustable impedance.

13. The apparatus of claim 12, further comprising means for processing, the means for processing comprising:
means for generating a first signal;
means for generating a second signal; and
means for generating a third signal, wherein the impedance of the power amplifier load tuner is adjusted based on the first signal, the impedance of the receive tuner is adjusted based on the second signal, and the impedance of the antenna tuner is adjusted based on the third signal.

14. The apparatus of claim 13, wherein the means for processing is included in a modem of a wireless device.

15. The apparatus of claim 13, wherein the means for processing is integrated into a radio frequency integrated circuit.

16. The apparatus of claim 13, wherein the means for processing further comprises:
means for sending the first signal to the power amplifier load tuner to adjust the impedance of the power amplifier load tuner during a first time period based on a use case of a wireless device;
means for sending the third signal to the antenna tuner to adjust the impedance of the antenna tuner during the first time period based on the use case of the wireless device; and
means for sending the second signal to the receive tuner to adjust the impedance of the receive tuner during a second time period based on the adjusted impedance of the antenna tuner,
wherein the first time period precedes the second time period, and wherein the use case of the wireless device is associated with a transmit configuration.

17. The apparatus of claim 13, wherein the means for processing further comprises:
means for sending the second signal to the receive tuner to adjust the impedance of the receive tuner during a first time period based on a use case of a wireless device;
means for sending the third signal to the antenna tuner to adjust the impedance of the antenna tuner during the first time period based on the use case of the wireless device; and
means for sending the first signal to the power amplifier load tuner to adjust the impedance of the power amplifier load tuner during a second time period based on the adjusted impedance of the antenna tuner,
wherein the first time period precedes the second time period, and wherein the use case of the wireless device is associated with a receive configuration.

18. A method comprising:
adjusting an impedance of a power amplifier load tuner included in a transmit path;
adjusting an impedance of a receive tuner included in a receive path; and
adjusting an impedance of an antenna tuner coupled to the transmit path and to the receive path.

19. The method of claim 18, wherein the impedance of the power amplifier load tuner, the impedance of the receive tuner, and the impedance of the antenna tuner are adjusted based on a use case of a wireless device.

20. The method of claim 18, wherein the use case of the wireless device is associated with a transmit configuration or a receive configuration.
